(19) United States
(12) Patent Application Publication
(10) Pub. No.: US 2024/0385794 A1
(43) Pub. Date: Nov. 21, 2024

(54) Content Display Device and Methods of Selecting and Displaying Content

(71) Applicant: Tuneshine, Inc., Oakland, CA (US)

(72) Inventor: Tobias Armsden Butler, Oakland, CA (US)

(21) Appl. No.: 18/662,008

(22) Filed: May 13, 2024

Related U.S. Application Data
(60) Provisional application No. 63/467,467, filed on May 18, 2023.

(51) Int. Cl. G06F 3/14

(52) U.S. Cl. CPC G06F 3/14

(57) ABSTRACT

Display devices and methods of operating the display devices may include a housing and a display screen mounted to the housing. A processor disposed within the housing is operatively connected to the display screen. A memory system disposed within the housing is operatively associated with the processor. A communications interface system disposed within the housing and operatively associated with the processor receives artwork data relating to audio source material. The processor operates the display screen to display the artwork data when the audio source material is being played on a content player physically separate from the display device.

### CROSS-REFERENCE TO RELATED APPLICATION

This application claims the benefit of U.S. Provisional Patent Application No. 63/467,467, filed on May 18, 2023, which is hereby incorporated herein by reference for all that it discloses.

### TECHNICAL FIELD

The present invention relates to display systems in systems in general and more specifically to systems and methods of displaying content relating to audio source material.

### SUMMARY OF THE INVENTION

One embodiment of a display device may include a housing and a display screen mounted to the housing. A processor disposed within the housing is operatively connected to the display screen. A memory system disposed within the housing is operatively associated with the processor. A communications interface system disposed within the housing and operatively associated with the processor receives artwork data relating to audio source material. The processor operates the display screen to display the artwork data when the audio source material is being played by a content player separate from the display device.

Another embodiment of a display device may include a housing and a display screen mounted to an open front of the housing so that the display screen defines a generally square face portion of the display device and so that the display screen and the housing together define an interior cavity therein. A processor disposed within the interior cavity defined by the housing and the display screen is operatively associated with the display screen. A memory system disposed within the interior cavity is operatively associated with the processor. A communications interface system disposed within the interior cavity and operatively associated with the processor receives artwork data relating to audio source material. The processor operates the display screen to display the artwork data when the audio source material is being played by a content player separate from the display device.

Also disclosed is a method of displaying artwork data associated with audio source material that may involve: Providing a display device having a housing, a display screen mounted to the housing, a processor disposed within the housing and operatively connected to the display screen, a memory system disposed within the housing and operatively associated with the processor, and a communications interface system disposed within the housing and operatively associated with the processor; and operating the display device to receive at the display device, via the communications interface system, artwork data relating to audio source material, the processor of the display device operating the display screen to display the artwork data when the audio source material is being played by a content player separate from the display device.

Also disclosed is a non-transitory computer-readable storage medium having computer-executable instructions embodied thereon that, when executed by at least one computer processor, cause the processor to operate a display device operatively associated with a content player separate from the display device to receive at the display device, via a communications interface system of the display device, artwork data relating to audio source material, a processor of the display device operating a display screen of the display device to display the artwork data when audio source material is being played by the content player.

### BRIEF DESCRIPTION OF THE DRAWINGS

Illustrative and presently preferred exemplary embodiments of the disclosed instrumentalities are shown in the drawings in which:

FIG. 1 is a front view in perspective of an embodiment of a display device according to the disclosed instrumentalities;

FIG. 2 is a schematic block diagram of the display device;

FIG. 3 is a rear view in perspective of the display device depicted in FIG. 1;

FIG. 4 is a plan view of the display device depicted in FIGS. 1 and 3 with the display removed to show the interior cavity defined by the housing;

FIG. 5 is a schematic representation of a network-based environment in which the display device may be used;

FIG. 6 is a flow chart of one embodiment of a method for displaying content data on the display device;

FIG. 7 is a schematic representation of a Service Client aggregation process;

FIGS. 8(a-d) are schematic representations of a method of using proximity detection as a contextual data source;

FIG. 9 is a flow chart of a method of prioritizing data sources; and

FIG. 10 is a schematic representation of elements involved in an example illustrating the effect of the prioritization method illustrated in FIG. 9.

### DETAILED DESCRIPTION OF THE PREFERRED EMBODIMENTS

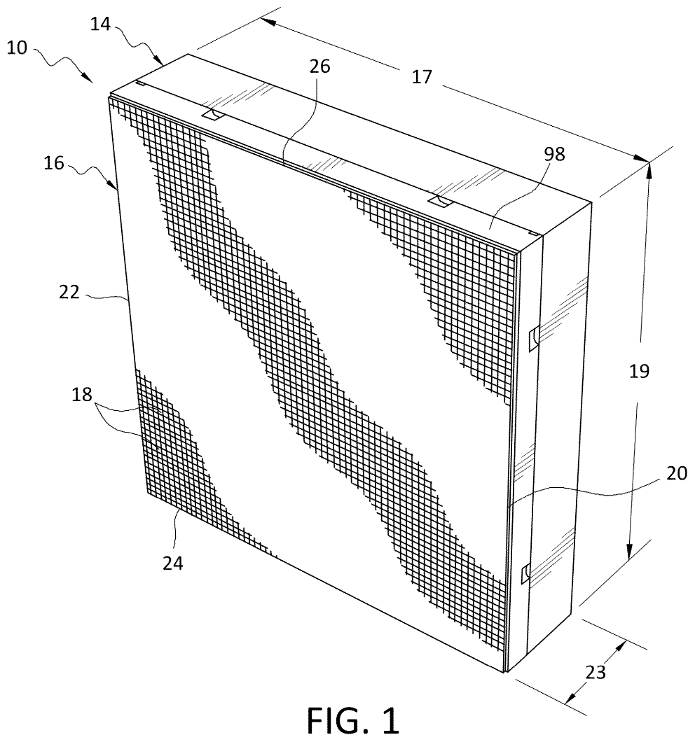

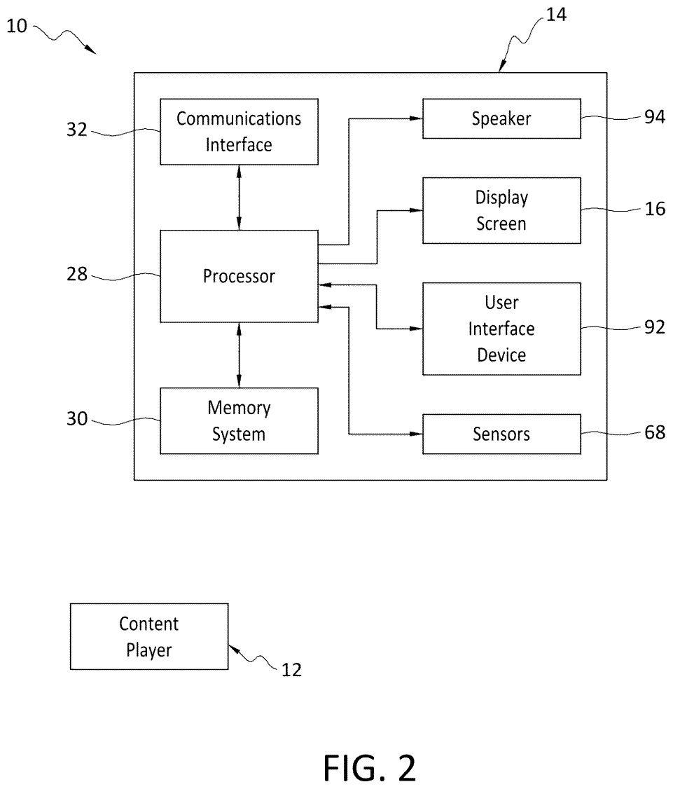

One embodiment of a display device 10 according to the disclosed instrumentalities is shown and described herein as it may be used to display content or artwork data (which may be collectively referred to herein in the alternative as “artwork”) associated with audio source material being played by a content player 12 separate from display device 10. See FIGS. 1 and 2. Briefly, display device 10 may comprise a housing 14 and a display screen 16 mounted thereto. Display screen 16 may comprise a display that lacks a bezel or surrounding perimeter so that individual pixels 18 of display screen 16 extend substantially between a right edge 20 and a left edge 22 of display screen 16, as best seen in FIG. 1. Individual pixels 18 also extend substantially between a bottom edge 24 and a top edge 26 of display screen 16. Housing 14 may be sized so that it is substantially coincident with the dimensional extent (e.g., width 17 and height 19) of display screen 16 so that the overall visual impression created by display device 10 is that of a border-less or bezel-less display, as also best seen in FIG. 1.

In the particular embodiments shown and described herein, display screen 16 may comprise a substantially square configuration having an aspect ratio (i.e., ratio of width 17 to height 19) of about 1:1. Display screen 16 may also have a resolution of less than about 49 pixels/cm², such as a resolution of about 16 pixels/cm². In some embodiments, display screen 16 produces a maximum luminance of at least about 1500 candelas/m² or ‘nits,’ such as a maximum luminance of about 1800 nits.

With reference now primarily to FIG. 2, display device 10 may also comprise a processor 28 and memory system 30, both of which may be disposed within housing 14. Processor 28 is operatively connected to display screen 16, whereas memory system 30 is operatively associated with processor 28. Display device 10 may also include a communications interface system 32 operatively associated with processor 28. Communications interface system 32 receives, among other data, content or artwork data, such as album art, relating to audio source material playing on (or desired to be played on) content player 12 physically separate from display device 10.

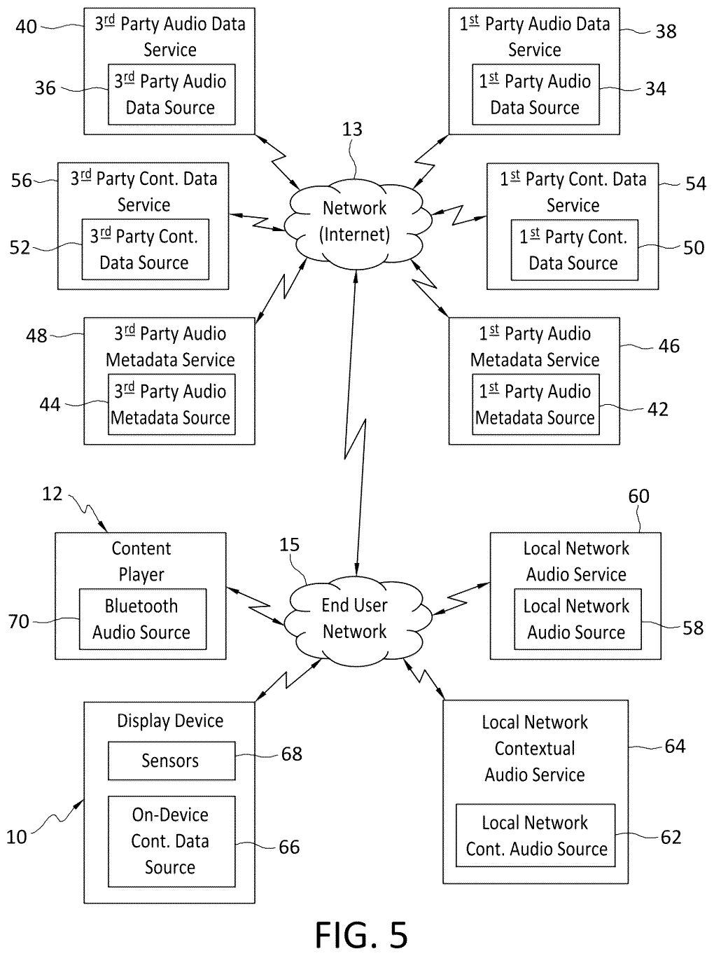

Referring now primarily to FIG. 5, display device 10 and separate content player 12 may be used in conjunction with a wide range of first- and third-party audio sources 34 and 36 for providing audio data. Audio data may comprise any of a wide range of audio source material including music, podcasts, audio books, and the like. First- and third-party audio sources 34 and 36 may be accessed via one or more corresponding first- and third-party audio data servers or services 38 and 40 which may be operatively connected to a network 13, such as the Internet.

Display device 10 and content player 12 may also be used in conjunction with a wide range of first- and third-party audio metadata sources 42 and 44 for providing audio metadata. As will be described in further detail herein, audio metadata may comprise at least content and artwork data suitable for display on display device 10. However, audio metadata may also comprise any of a wide range of other data relating to the audio content, such as, for example, song titles, artists, album names, podcast names, and audio book titles, and the like. First- and third-party audio metadata sources 42 and 44 may be accessed via one or more corresponding first- and third-party audio metadata servers or services 46 and 48, which may also be operatively connected to network 13. In some embodiments, first- and third-party audio metadata services 46 and 48 may comprise all or portions of first- and third-party audio data services 38 and 40.

Device 10 and content player 12 also may be used in conjunction with first- and third-party contextual data sources 50 and 52 for providing contextual data. As will be described in greater detail herein, contextual data may comprise any of a wide range of data unrelated to audio data and audio metadata and may include, without limitation, data relating to the time and date, temperature, weather, or news. The first- and third-party contextual data sources 50 and 52 may be accessed via corresponding first- and third-party contextual data servers or services 54 and 56 which also may be operatively connected to network 13.

In many embodiments, display device 10 and content player 12 will be used in conjunction with an end user network 15 operatively connected to network 13. In such embodiments, device 10 and content player 12 may also be used in conjunction with a local network audio source 58 for providing audio data. Local network audio source 58 may be accessed via a local network service or device 60. In some embodiments, device 60 may be content player 12, although it need not be.

Similarly, display device 10 and content player 12 may be used in conjunction with a local network contextual data source 62. Local network contextual data source 62 provides contextual data unrelated to audio data, but related to local aspects of end user network 15, such as, for example, ambient (e.g., indoor or outdoor) temperature, whether the user is at t home or not, or other information not available on network 13. Local network contextual data source 62 may be accessed via a local network contextual data service or device 64. In some embodiments, local network contextual data source 62 may comprise all or a portion of an on-device contextual data source 66 provided on display device 10. Contextual data provided via on-device contextual data source 66 may differ from contextual data accessed via local network contextual data service or device 64 and may include, for example, data related to ambient brightness, signal strength of local radio sources, a list of devices accessible on the end user network 15, and relative noise level near device 10. Some contextual data from on-device contextual data source 66 may be produced by one or more sensors 68 provided on display device 10.

Display device 10 and content player 12 also may be used in conjunction with one or more Bluetooth audio sources 70 operatively connected to end-user network 15. As will be described in much greater detail below, Bluetooth audio source(s) 70 may be used to reproduce audio data (e.g., via a speaker) or send audio metadata to device 10 via a Bluetooth connection. In some embodiments, Bluetooth audio source 70 may comprise content player 12.

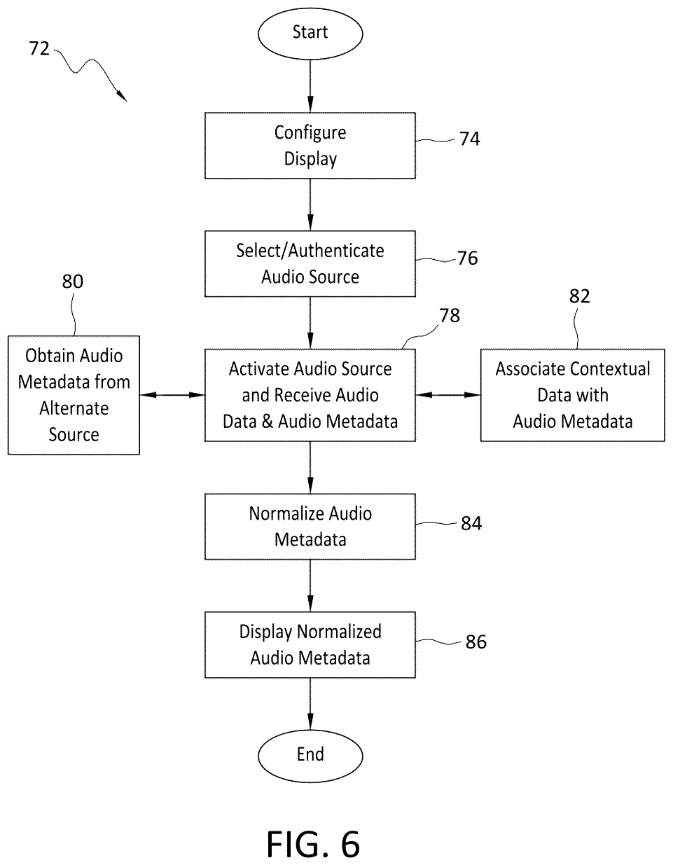

Referring now to FIG. 6, with occasional reference to FIG. 5, display device 10 may be operated in accordance with method 72 to display content or artwork data related to the audio source material being consumed by a user, i.e., being played by or in conjunction with separate content player 12. Assuming that display device 10 has already been configured (e.g., at step 74 of method 72), the user would select, at step 76, a desired audio source. The audio source may be accessed via any one of first-party audio source 34, third-party audio source 36, or local network audio source 58. Method 72 then activates the selected audio source to receive audio data. Method 72 may also obtain corresponding audio metadata from an appropriate audio metadata source 42 and/or 44 at step 80. In embodiments wherein contextual data are desired to be used, contextual data from an appropriate contextual data source, such as any of contextual data sources 50, 52, 62, and 66, then method 72 associate the contextual data source with the audio data and/or audio metadata at step 82. Thereafter, the audio metadata are normalized at step 84 before being displayed on display device 10 at step 86.

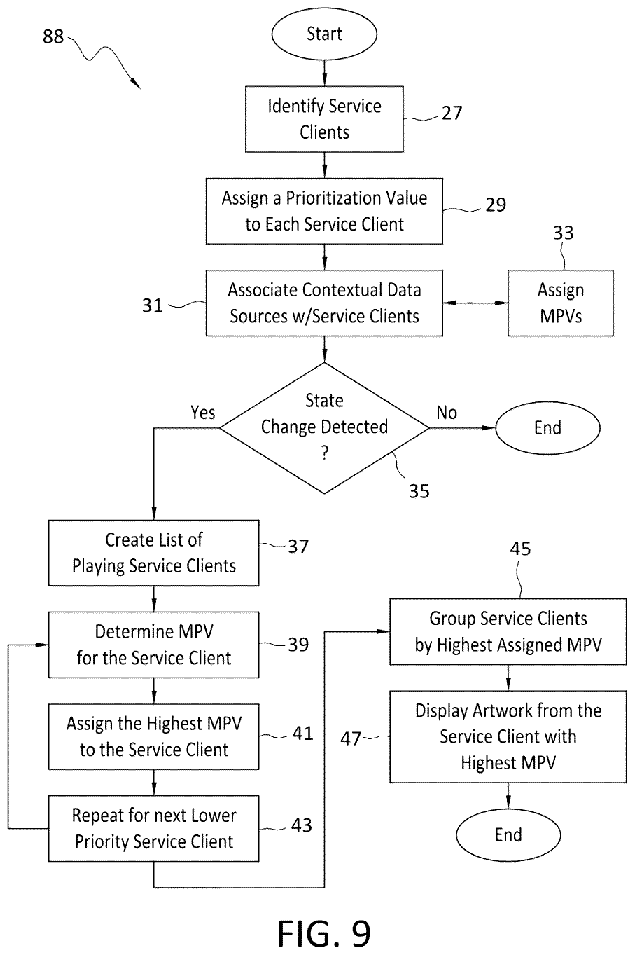

The relatively large number of audio sources (e.g., comprising any of audio sources 34, 36, and 58), audio metadata sources (e.g., comprising any of audio metadata sources 42 and 44), and contextual data sources (e.g., comprising any of contextual data sources 50, 52, 62, and 66) operatively connected to networks 13 and 15 can create difficulties in ensuring that the correct artwork data (i.e., as a part of audio metadata) and contextual data are correlated with the audio data currently being consumed by the user, regardless of the particular audio source being used. Method 88, illustrated in FIG. 9, may be used to prioritize and coordinate the various sources of audio data, audio metadata, and contextual data so that display device 10 displays the right artwork at the right time no matter which audio source is being used.

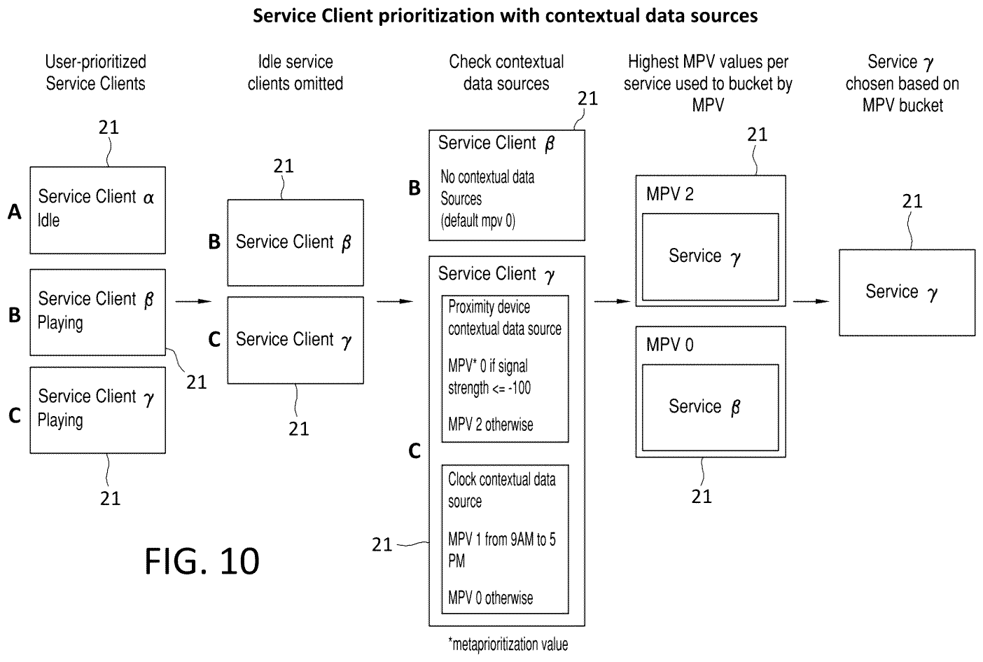

Briefly, and as will be described in much greater detail below with reference to FIGS. 9 and 10, prioritization method 88 uses a combination of user-assigned prioritization values, metaprioritization values (MPVs), and the state of each Service Client 21 to determine the particular Service Client 21 that will have artwork transmitted to and displayed on display device 10.

A significant advantage of the display device according to the instrumentalities disclosed herein is that provides a consumer of audio material with an enhanced visual experience that is different in kind, not just degree, from the conventional experience of consuming audio material. For example, and in contrast to the content or artwork typically displayed on a content player (e.g., smart phone) along with the audio material, the bezel-less appearance of display device 10 creates a visual aesthetic that ensures that the content or artwork is viewed as an object unto itself rather than merely a feature on a larger display. Moreover, and in embodiments having a relatively low-resolution display screen 16, display device 10 provides a unique visual aesthetic that is not found with higher resolution displays typically associated with content players. Still further, the relatively large size and high luminance provided by display device 10 adds to the visual aesthetic by allowing display device 10 to partially illuminate the surrounding environment or room in which it is used.

Still other advantages are associated with the square format (i.e., 1:1 aspect ratio) provided by display device 10. For example, content or artwork data, such as album art of the type typically presented on the sleeves of vinyl records or the cases of CDs, is also in a square or 1:1 aspect ratio. The square or 1:1 aspect ratio of display device 10 allows such artwork to be displayed in its native format, i.e., without the need crop or change the aspect ratio of the artwork, which would otherwise detract from the visual aesthetic. Moreover, the artwork displayed by display device 10 may also be static or animated, thereby providing for additional aesthetic functionality.

Still other advantages are associated with the normalization process 84. Briefly, normalization process 84 analyzes the audio metadata to identify and/or separate the content or artwork data from other data comprising the audio metadata. Normalization process 84 also reformats the artwork data so that it can be displayed on display device 10. The normalization process 84 thereby allows display device 10 to display the content or artwork without accompanying metadata, such as song titles, artists, album names, podcast names, audiobook titles, etc., thereby further maintaining isolation of the content or artwork data from its digital context.

Still other advantages are associated with the method 88 used to prioritize and coordinate the various data sources. For example, and as briefly described earlier, the large number of audio sources, audio metadata sources, and contextual data sources accessible by display device 10 creates difficulties in ensuring that the correct artwork data and contextual data are correlated with the audio data currently being consumed by the user. The methods associated with the disclosed instrumentalities prioritize and coordinate the various sources of audio data, audio metadata, and contextual data so that display device 10 displays the right artwork at the right time regardless of the particular audio source that is being used. The disclosed instrumentalities therefor represent an improvement in the technology of audio data and audio metadata source selection, prioritization, and reformatting.

Having briefly described the systems, methods, and devices of the disclosed instrumentalities, as well as some of their more significant features and advantages, various embodiments of the disclosed instrumentalities will now be described in detail. However, before proceeding with the description it should be noted that while the disclosed instrumentalities are shown and described as they could be used in conjunction with conventional sources of audio data and audio metadata provided in commonly used formats, the disclosed instrumentalities could be used in conjunction with any of a wide range of source material provided in any of a wide range of formats, either now known in the art or that may be developed in the future, as would become apparent to persons having ordinary skill in the art after having become familiar with the teachings provided herein. Therefore, the disclosed instrumentalities should not be regarded as limited to any particular source material having any particular format.

Referring back now to FIGS. 1-4, display device 10 may comprise housing 14 and display screen 16. Housing 14 may define an internal cavity 90 therein sized to receive various internal components of display device 10, including, but not limited to, processor 28, memory system 30, communications interface system 32, and sensor(s) 68.

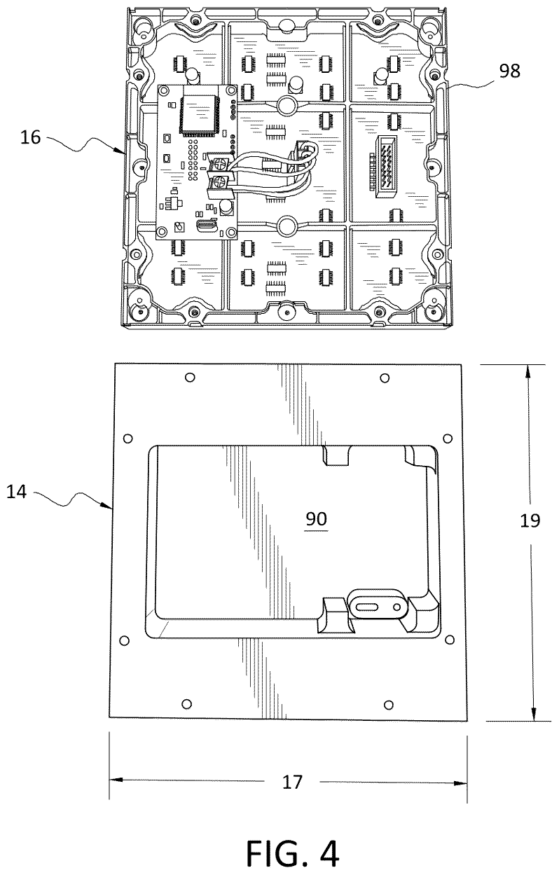

In embodiments wherein display device 10 comprises a square display having a width-to-height ratio of 1:1, housing 14 may comprise a generally square prism shape having a front face 96 that is substantially similar or identical in dimensional extent to display screen 16. See FIG. 4. So sizing housing 14 will provide display device 10 with a substantially bezel-less or border-less visual appearance, as best seen in FIG. 1. The border-less or bezel-less configuration ensures that the content or artwork displayed on display screen 16 is viewed as an object unto itself rather than as a feature on a larger display. Moreover, eliminating bezels at least on the top and sides of display device 10 gives the appearance that the illumination provided by display screen 16 is coming from the content or artwork itself, rather than from a digital display. In the particular embodiments shown and described herein, housing 14 has a uniform thickness or depth 23. However, in other embodiments, the thickness or depth 23 of the bottom portion of housing 14 may be greater than the thickness or depth 23 of the top portion, so that display screen 16 is generally angled upwardly.

Alternatively, and in some embodiments, front face 96 of housing 14 may be larger than display screen 16 in one or more dimensional extents, i.e., width 17, height 19, or both, resulting in the formation of a border or bezel around at least a portion of display screen 16. For example, the height 19 of housing 14 may be made greater than the height of display screen 16 to create a bezel or border that extends below bottom edge 24 of display screen 16. Providing display device 10 with a single bezel or border along the bottom edge 24 of display screen 16 does not break the illusion of the content or artwork displayed on display screen 16 itself being the object rather than the display device 10.

Housing 14 may be fabricated from any of a wide range of materials, such as wood, plastic, metals, or metal alloys, as may be desired. If housing 14 is made of a material that blocks radio waves, allowances should be made to provide display device 10 with an antenna (not shown), or otherwise ensure that at least a portion of display device 10, e.g., either housing 14 or display screen 16, allows radio waves to be received by communications interface system 32. Consequently, the disclosed instrumentalities should not be regarded as limited to housings 14 fabricated from any particular material. However, by way of example, housing 14 is fabricated from wood.

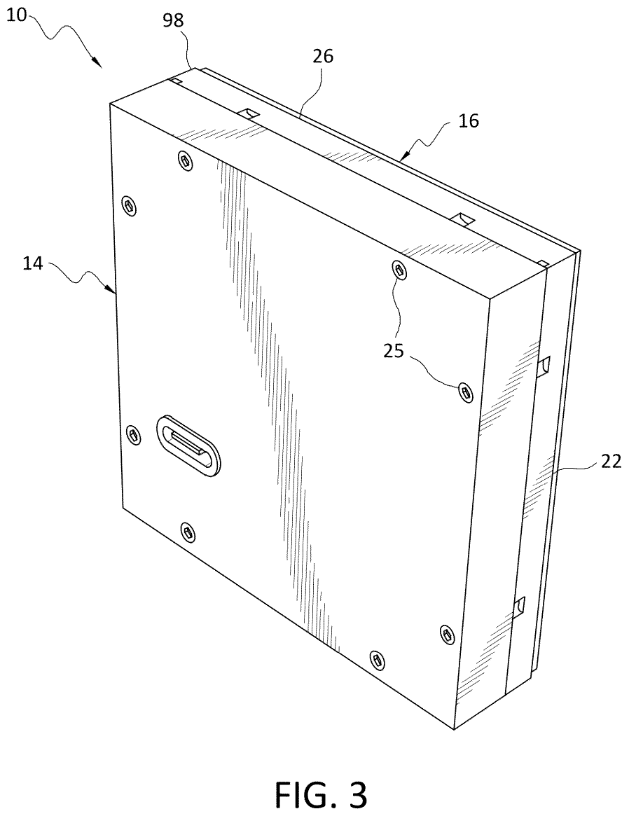

Display screen 16 may comprise a display that lacks a bezel or surrounding perimeter so that individual pixels 18 of display screen 16 extend substantially between the right and left edges 20 and 22 of display screen 16 as well as the bottom and top edges 24 and 26 of display screen 16, as best seen in FIG. 1. Display screen 16 may be mounted on a frame or chassis 98 that receives the various electronic components required by display screen 16. See FIG. 4. Frame or chassis 98 may also allow display screen 16 to be conveniently secured or mounted to housing 14, such as by one or more screws 25, as best seen in FIG. 3.

Display screen 16 may comprise a color display having a substantially square configuration with an aspect ratio, i.e., ratio of screen width 17 to screen height 19, of about 1:1. See also FIG. 1. Display screen 16 may have any desired size. In the embodiments shown and described herein, display screen 16 has a width 17 of about 16 cm and height 19 of about 16 cm.

In addition, it is generally preferred, but not required, that display screen 16 produce sufficient brightness to at least partially illuminate the surrounding environment or room in which it is used, thereby making images displayed on display device 10 visually distinct from other devices with digital displays, such as TVs, computers, and smartphones. For example, and in one embodiment, display screen 16 comprises a matrix of individual light emitting diodes (LEDs) or pixels 18. LEDs generally result in a brighter and higher-contrast image than other common display technologies, such as LCD displays. In some embodiments, display screen 16 has a maximum luminance of greater than about 1500 candelas/m² or nits. In the particular embodiments shown and described herein, display screen has a maximum luminance of about 1800 nits.

In some embodiments display screen 16 is of relatively low resolution, so that individual pixels 18 of display screen 16 are visually discernable to the human eye at normal viewing distances. The relatively low resolution of display screen 16 thereby contributes to the overall visual aesthetic of display device 10. Generally speaking, display screen resolutions of less than about 49 pixels/cm² will provide the desired aesthetic. By way of example, one embodiment of display screen 16 has a resolution of about 16 pixels/cm². Thus, in an exemplary embodiment wherein display screen 16 has a width 17 and height 19 of about 16 cm, display screen 16 will have a resolution of 64×64 pixels 18. Alternatively or otherwise, display screen 16 may have higher resolutions.

Referring now primarily to FIG. 2, processor 28 of display device 10 may comprise one or more general purpose programmable processors (e.g., electronic computers) and associated systems (e.g., cache memory systems, I/O systems, etc.) of the type that are well-known in the art or that may be developed in the future that are or would be suitable for operating display device 10 in accordance with the teachings provided herein. Memory system 30 may contain instructions for processor 28, storage for artwork data, as well as storage for information and data required for the operation of display device 10. Memory system 30 may comprise any of a wide range of memory systems that are well-known in the art or that may be developed in the future that would provide the require memory capacity. However, because processors 28 and memory systems 30 suitable for use in conjunction with the disclosed instrumentalities are commercially available and could be readily provided by persons having ordinary skill in the art after having become familiar with the teachings provided herein, the particular processor 28 and memory system 30 that may be used in conjunction with the disclosed instrumentalities will not be described in further detail herein.

Processor 28 may be programmed or configured to operate in accordance with the methods described herein. The methods may be embodied in software or firmware provided on non-transitory computer-readable storage media (e.g., memory system(s) 30) accessible by processor 28. The software or firmware may comprise computer-executable instructions that, when performed by processor 28, cause processor 28 to operate the various systems and implement the various methods and functionalities in accordance with the teachings provided herein.

Still referring to FIG. 2, display device 10 may also comprise one or more communications interface systems 32 operatively connected to processor 28. Communications interface system(s) 32 allows processor 28 to communicate with devices and systems external to display device 10. As such, communications interface system(s) 32 may comprise one or more wired or wireless communications systems for communicating with such external systems and devices. By way of example, in the particular embodiments shown and described herein, the communication interface system(s) 32 may include an intermediate-range radio transceiver configured to communicate with various external devices and systems via one or more intermediate-range wireless communications protocols, such any of the IEEE 802.11x communications protocols, commonly referred to as “Wi-Fi.” Communication interface system(s) 32 may also comprise a short-range radio transceiver configured to communicate with various external devices and systems via one or more short-range wireless communications protocols, such as any of a wide range of Bluetooth wireless communications protocols. Alternatively, other types of wireless communications systems and communications protocols may be used as well.

Communication interface system(s) 32 may also include a wireline communications port, such as an Ethernet port or serial communications port (not specifically shown), for receiving communications via a wired connection, such as via an Ethernet or serial communications cable. However, because communication interface system(s) 32 suitable for use in conjunction with the disclosed instrumentalities could be readily provided by persons having ordinary skill in the art after having become familiar with the teachings provided herein, the communication interface system(s) 32 that may be used in conjunction with the disclosed instrumentalities will not be described in further detail herein.

Display device 10 may also include one or more sensor(s) 68 for sensing one or more conditions local to display device 10. Sensor(s) 68 may be operatively associated with processor 28. The data produced by sensor(s) 68 may comprise contextual data and may include, for example, ambient brightness, signal strength of local radio sources, a list of devices accessible on end user network 15, and relative noise level near display device 10. However, because sensors suitable for sensing such conditions are well-known in the art and could be readily provided by persons having ordinary skill in the art after having become familiar with the teachings provided herein, the particular sensor(s) 68 that may be used in conjunction with display device 10 will not be described in further detail herein.

Display device 10 may also be provided with one or more power supplies (not specifically shown) to provide electrical power to operate display device 10. Example power supplies suitable for use with display device 10 include primary (i.e., non-rechargeable) and secondary (i.e., rechargeable) batteries or wired power supplies. However, because power supplies of the type suitable for providing electrical power to display device 10 are well known in the art and readily commercially available, the particular power supply that may be used in conjunction with the various embodiments of display device 10 will not be described in further detail herein.

In some embodiments, display device 10 may also comprise one or more user input device(s) 92 to allow a user to directly operate and/or interface with display device 10. Such user input device(s) 92 may include one or more switches, buttons, rotary encoders, or other interactive elements (not specifically shown). Exemplary functions that may be accessed or controlled by user input device(s) 92 include, but are not limited to “play/pause,” “next item,” “previous item,” “volume up,” and “volume down.” The user input device(s) 92 may be mounted at any convenient location on housing 14, such as on the sides, top or back. It is generally preferred, but not required, that the user input device(s) 92 be mounted to housing 14 so as not to detract from the overall visual aesthetic of display device 10.

Display device 10 may also comprise one or more audio transducers, such as one or more speaker(s) 94, to allow display device 10 to play audio content and/or provide aural feedback relating to the operation of any provided user input device(s) 92 or other functions of display device 10 that may be remotely accessed. If provided, speaker(s) 94 may be mounted within housing 14 so that it or they do not detract from overall aesthetic of display device 10. By way of example, in some embodiments, one or more of the speakers 94 may be mounted to the sides or rear of housing 14. Alternatively, and in other embodiments, one or more speakers 94 may be mounted behind display screen 16 so that it or they are concealed or hidden by display screen 16.

As briefly mentioned earlier, content player 12 is physically separate from display device 10 and may be used to play the desired audio content. Content player 12 may comprise any of a wide range of systems and devices now known in the art or that may be developed in the future that are, or would be suitable for this purpose. Examples of content players 12 suitable for use with display device 10 include, but are not limited to, smart phones, tablet computers, laptop computers, and dedicated music players. As will be explained in further detail below, certain types of content players 12 also may be used to configure or control display device 10, whereas other types of content players 12 may require the use of a separate system or device to configure and/or control display device 10 (referred to herein in the alternative as a “Configuration Device”).

Referring now to FIG. 5, and as briefly described above, display device 10 and separate content player 12 may be used in conjunction with a wide range of first- and third-party audio sources 34 and 36 of audio data. Audio data may comprise any of a wide range of audio source material including, but not limited to, music, podcasts, audio books, and other audio source material. The first- and third-party audio sources 34 and 36 may be accessed via one or more corresponding first- and third-party audio data services 38 and 40 operatively connected to network 13.

Display device 10 and content player 12 may also be used in conjunction with a wide range of first- and third-party audio metadata sources 42 and 44 of audio metadata. While audio metadata may include content and artwork data suitable for display on display device 10, audio metadata may also include other data relating to the audio content, such as, for example, song titles, artists, album names, podcast names, and audio book titles, and the like. The first- and third-party audio metadata sources 42 and 44 may be accessed via one or more corresponding first- and third-party audio metadata services 46 and 48 operatively connected to network 13. In some embodiments, first- and third-party audio metadata services 46 and 48 may comprise all or portions of first- and third-party audio data services 38 and 40, although other arrangements are possible.

Device 10 and content player 12 may also be used in conjunction with first- and third-party contextual data sources 50 and 52 of contextual data. Contextual data may comprise data unrelated to the audio data and may include, without limitation, data relating to the time and date, temperature, weather, or news. The first- and third-party contextual data sources 50 and 52 may be accessed via corresponding first- and third-party contextual data services 54 and 56 operatively connected to network 13.

Display device 10 and content player 12 may be used in conjunction with end user network 15. End user network 15 may be operatively connected to network 13. In such instances, device 10 and content player 12 may also be used in conjunction with local network audio source 58. Local network audio source 58 may be accessed via local network service or device 60. In some embodiments, device 60 may be content player 12, although it need not be. Similarly, display device 10 and content player 12 may be used in conjunction with local network contextual data source 62. Local network contextual data source 62 may comprise contextual data unrelated to audio data, but related to local aspects of end user network 15, such as, for example, indoor temperature, whether the user is at home or not, or other information not available on network 13. Local network contextual data source 62 may be accessed via local network contextual data service or device 64.

In some embodiments, local network contextual data source 62 may comprise on-device contextual data source 66 provided on display device 10. Contextual data provided via on-device contextual data source 66 may differ from contextual data accessed via local network contextual data service or device 64 and may include, for example, data produced by one or more sensors 68 provided on display device 10, such as ambient brightness, signal strength of local radio sources, a list of devices accessible on the end user network 15, and relative noise level near device 10.

Display device 10 and content player 12 may also be used in conjunction with one or more Bluetooth audio sources 70 operatively connected to end-user network 15. Bluetooth audio source(s) 70 may be used to reproduce audio data (e.g., via a speaker) or send audio metadata to device 10 via a Bluetooth connection. In some embodiments, Bluetooth audio source 70 may comprise content player 12.

Referring now to FIG. 6, display device 10 may be operated in accordance with method 72 to display content or artwork data related to audio source material being played by or in conjunction with content player 12. A first step 74 of method 72 involves configuring display device 10. Configuration step 74 configures display device 10 to display (e.g., on display screen 16) the appropriate content or artwork when connected to a first-party or third-party server. In order to so configure display device 10, there should be a means or method of providing text input so that data required for the configuration process can be provided during configuration step 74. If display system 10 is provided with one or more user input device(s) 92 (FIG. 2), then configuration step 74 may be conducted via operation of the user input device(s) 92. Alternatively, configuration step 74 may be conducted via wired or wireless communication with communication interface system 32 of display device 10. However, it should be noted that in embodiments utilizing Bluetooth content or artwork transmission, additional configuration may not be required beyond the requirement of pairing a device with AVRCP (Audio/Video Remote Control Profile) capabilities.

Configuration with On-Device Input:

In embodiments wherein display device 10 is provided with one or more user interface device(s) 92, display device 10 may receive input directly via user input device(s) 92. Alternatively, display device 10 may be provided with a suitable port, such as a USB port (not shown) to allow a separate input device, such as a keyboard (also not shown), to be connected to display device 10. The user input device(s) 92 and/or separate input device may then be used to enter any required information for configuration step 74.

### Configuration Via Bluetooth:

Display device 10 may advertise itself as a Bluetooth device and allow a Bluetooth-capable device, i.e., a Configuration Device, to provide the required information. For example, a laptop or smartphone with a built-in keyboard (or other input device, such as a touch screen) may be paired with display device 10 to ascertain whether or not configuration is required and provide the necessary configuration data. Display device 10 then may be configured to run as a Bluetooth peripheral and make available Bluetooth services and characteristics to reveal the current state of device configuration as well as accept configuration data to be written to display device 10.

### Configuration Via Wi-Fi Access Point:

Display device 10 also may be configured to create a wireless 802.11x access point which may be connected to a nearby Configuration Device. The wireless access point may either be discovered manually by the user, or in conjunction with an application that is configured to automatically connect the Configuration Device to the Wi-Fi network created by display device 10.

When creating the access point, display device 10 may also start a web server (not specifically shown in FIG. 5) that may reveal the current state of device configuration as well as accept configuration data to be written to display device 10. The configuration state can be revealed in a format such as JSON, XML, or HTML if it is necessary to render a web page to configure display device 10, and configuration data can be written to display device 10 as allowed by HTTP requests (for example, in the POST body of an HTTP request to the web server running on the device).

Aspects of configuration step 74 may differ depending on whether display device 10 connects to a first-party configuration server (e.g., which may be implemented on first-party service 38) in order to receive audio content or directly to a third party provider of audio metadata (e.g., third-party service 48).

Configuration in Conjunction with a First-Party Configuration Server:

Components, systems, and devices required for configuration with a first party configuration server (e.g., as may be implemented on first-party service 38) include display device 10; a Configuration Device with rich input capabilities, such as content player 12, or a separate laptop or tablet computer; first-party configuration server, again which may be implemented on first-party service 38; and one or more third-party audio metadata sources, e.g., third party service 48. The configuration steps may be as follows:
A. Display device 10 and Configuration Device (e.g., content player 12) are powered on.
B. If configuration is required, display device 10 activates the required transmission protocol for transmitting configuration data, for example, starting a Bluetooth service or creating a wireless access point and a web server.
C. The user uses the Configuration Device (e.g., content player 12) to connect to display device 10. This may include auto-discovery facilitated by a custom application that is either loaded on a web browser or downloaded to the Configuration Device.
D. The application on the Configuration Device reads the current configuration state from display device 10.
E. If the Configuration Device does not have credentials for connection to the configuration server (e.g., as may be implemented on first-party service 38), it must provide a means to create credentials for a user account that can be accessed from Configuration Device or display device 10.
F. If this is not the first time display device 10 has been configured, the Configuration Device may need to authenticate the user's ownership of display device 10 by transmitting a token which can be matched with a token stored in non-volatile memory on display device 10.
G. The Configuration Device displays a user interface (UI) to allow input of any required configuration information. This may include information transmitted from display device 10, such as a list of wireless networks that are within range of display device 10.
H. If display device 10 does not have valid credentials to connect to the first-party configuration server, the Configuration Device uses its own server credentials to create a set of display device-specific credentials and transmits these credentials to display device 10.
I. The Configuration Device verifies the new configuration state of display device 10 by requesting the latest configuration state.
J. Display device 10 attempts to connect to the configuration server. If the connection is successful and configuration data can still be transmitted after connecting, display device 10 notifies the Configuration Device that the connection was successful.
K. If display device 10 cannot connect to the configuration server, it notifies (if available) the Configuration Device and the process repeats from step D.
   Configuration without a First-Party Configuration Server:

Components, systems, and devices required for configuration without a first party configuration server include: display device 10; Configuration Device with rich input capabilities, such as content player 12, or a separate laptop or tablet computer; and one or more third-party audio metadata sources, e.g., third-party service 48. The configuration steps may be as follows:
A. Perform steps A-C above for configuration with a first party configuration server.
B. The application on the Configuration Device (e.g., content player 12) reads the current configuration state from display device 10.
C. The Configuration Device shows a UI to authenticate a user to a third-party audio metadata service 48 using an authentication convention such as Oauth. The Configuration Device may also have existing third-party audio metadata source credentials stored.
D. Credentials for third-party audio metadata source are transmitted to display device 10.
E. Display device 10 attempts to connect to the third-party audio metadata service 48. If the connection is successful and configuration data can still be transmitted after connecting, display device 10 notifies the Configuration Device that the connection was successful.
F. If display device 10 cannot connect to the configuration server, it notifies (if available) the Configuration Device and the process repeats from step B.

Referring back now to FIG. 6, after configuration step 74 has been performed, the user may then select a desired audio source at step 76. As described earlier, audio source may be one or more of first-party audio source 34, third-party audio source 36, or local network audio source 58. Method 72 then activates the selected audio source and obtains corresponding audio data at step 78. Audio metadata may be obtained from an appropriate metadata source 42 or 44 at step 80.

More specifically, the artwork or content data, e.g., from first- or third-party metadata sources 42 and 44, may be transmitted to display device 10 either wirelessly using technologies such as Wi-Fi or Bluetooth, or via a wireline connection using technologies such as Ethernet or serial communications protocols. The particular method of receiving the content data varies depending on whether it is transmitted via Wi-Fi, Ethernet, or Bluetooth, as described immediately below. Regardless of the particular form of transmission, the signals are received by communications interface system(s) 32 of display device 10. See FIG. 2. The signals will be processed by processor 28 and transformed into the signal format used by display screen 16 to render an image of the artwork data.

### Wi-Fi Content Transmission:

Display device 10 may obtain credentials to connect to a Wi-Fi network (not separately shown), enabling transmission of data comprising the content or artwork for corresponding audio content at the time the audio content is being played on content player 12. Display device 10 may connect to different kinds of remote computers or servers in order to obtain the content or artwork data. Such remote computers or servers may include:
A remote first-party server (e.g., which may be implemented on first-party service 46) controlled by the manufacturer of display device 10;
A local server or computer (e.g., local network service or device 60) on end-user network 15 that is running software developed to make artwork available for display on display device 10; and
A server controlled by a third-party provider of audio content or metadata (e.g., third-party service 40, 42, or 48).

### Transmission Via Remote First-Party Server:

Display device 10 may connect to first-party server (e.g., which may be implemented on first-party service 46) that may subsequently authenticate display device 10 so that the correct content or artwork for corresponding audio content can be transmitted to display device 10. The address for first-party service 46 can be either hard-coded into the processor 28/memory system 30 of display device 10 and remain the same for the lifetime of display device 10. Alternatively, the server address can be transmitted to display device 10 during the configuration process 74 (FIG. 4), after which it may or may not be validated by comparing it against a valid list of server addresses or address patterns.

Display device 10 may be configured to present an identifier that uniquely identifies the device in the database of server 46 so that the corresponding content or artwork can be transmitted to display device 10. The identifier may be accompanied by an additional authorization token, which may be used to confirm the identity of display device 10 and prevent unauthorized or unintended use of the content or artwork data. The token may be transmitted separately or it may be combined with the device identifier in a serialized format which can be de-serialized on server 46.

Additionally, there may be a token rotation system that allows display device 10 to update its token without user interaction, which may involve additional tokens to facilitate the token rotation process or system. The token rotation process or system can be implemented using any of a wider range of authentication protocols such as Oauth. Alternatively, other industry standard or proprietary authentication protocols may be used as well.

The connection to server 46 can use either long-lived connection protocols, such as WebSockets, HTTP long polling, or UDP connections, or short-lived protocols, such as HTTP or HTTPS. Artwork or content data can be sent over these protocols as either a static or dynamic image in a compressed or uncompressed image format such as JPEG, WebP, GIF, PNG, or other binary image formats.

Artwork or content data can also be packaged with additional metadata that coordinates the presentation of the artwork or content data on display screen 16 of display device 10, for example by displaying different images at different times, or depending on environmental context (i.e., contextual data) such as time of day, brightness of the room, location, weather, temperature sensed by sensors 68 provided on display device 10, etc.

For long-lived connections, server 46 can send the content or artwork data in real-time to correspond with the audio content being played on content player 12. The connection generally will be open continuously, and the content or artwork can be displayed on display screen 16 of display device 10 immediately as soon as it is received. Alternatively, the content or artwork may be displayed at a later time, either determined by the client or as instructed by server 46.

For short-lived connections, display device 10 may periodically make requests to server 46. Thereafter, server 46 may respond with the binary image formats described above, which may or may not include additional metadata. Because the connection to server 46 is typically not continuous, this may include information about how frequently or when exactly to create the short-lived connections in order to coordinate the time of the transmission of the artwork when real-time transmission is not possible.

### Transmission Via Local Server or Device Controlled by the End-User:

The user of display device 10 could choose to install software on another device under the control by the user, such as local network audio service 60 (FIG. 5). In such instances, local network audio service 60 could be configured to transmit the content or artwork using a connection either originating from display device 10 or from the local network audio service 60.

The address of the local software could be discovered by display device 10 in multiple ways. For example:
The server 60 could signal the availability of artwork data using either a TCP or UDP port that is known by display device 10 to correspond to a source of artwork data.
Display device 10 could use a wireless or wired (e.g., Wi-FI or ethernet) connection to signal the availability of connections on a TCP or UDP port which could be discovered by the local server 60 and used to transmit the address and metadata required to connect to the local server 60.
The specific address of the local server 60 can be transmitted during the configuration process 74 (FIG. 6).

In any event, once the address of the local server 60 is discovered, content or artwork, along with any provided metadata, may be transmitted by the protocols described above for “Transmission via remote first-party server.”

### Transmission Via a Third-Party Provider of Audio Content or Metadata:

In some embodiments, a provider of audio content and/or metadata (e.g., via third-party services 40 and/or 48) may provide direct access to artwork data and other metadata about audio content via a public API. The display device may maintain credentials for consuming content for APIs for one or more audio content/metadata services, either serially or simultaneously.

Authentication for the third-party service 40 or 48 may be performed during the configuration process 74, at which time the necessary credentials to consume the API would be transmitted to display device 10.

### Ethernet Content Transmission:

As an alternative to Wi-Fi, the content or artwork and associated metadata (if provided) may be transmitted to display device 10 via a wired Ethernet connection, using the same protocols described above for Wi-Fi transmission.

### Bluetooth Content Transmission:

For a display device 10 with or without built-in audio transducer(s) 94, metadata for audio content could be transmitted via Bluetooth from a nearby device (e.g., content player 12) using a format such as AVRCP 1.4 or higher. This protocol could be used to display the artwork for audio content playing either on integrated speakers provided on display device 10 or on another audio device connected by Bluetooth or other means.

Referring now to FIGS. 5-7, step 84 of method 72 involves processing or normalizing the audio metadata so that they can be used interchangeably with display device 10. The software process of normalizing the audio metadata is referred to herein as an “Audio Metadata Service Client” or simply, Service Client 21

As described earlier with reference to FIG. 5, display device 10 can pull from multiple first- and third-party sources of audio metadata to determine the most appropriate content or artwork to display at a given time. This process may occur either as software or firmware running on display device 10 itself or via software running on a first party server.

More specifically, and as was briefly described above, the types of data sources may include the following:

First-party audio service 38: An audio service specific to display device 10 that provides audio data. First-party audio service 38 may also provide audio metadata which may or may not include artwork.

First-party audio metadata service 46: An audio service specific to display device 10 that provides metadata about audio content but may not provide the audio data itself.

Third-party audio service 40: A service accessible on the Internet (i.e., network 13) through software on one of the user's existing personal devices or content players 12 that provides audio data for reproducing audio content. Third-party audio service 40 may also provided audio metadata for that content that may or may not include artwork.

Third-party audio metadata service 48: A third-party service accessible on the Internet that provides metadata about audio content but may not provide the audio data itself.

Local network audio source 60: A source of audio data that exists as software on a device running on end user network 15 and provides a communication for audio metadata to be sent either to a first-party server or directly to display device 10.

Bluetooth audio source 70: A device, such as content player 12, that can reproduce audio or send audio metadata over Bluetooth that connects directly to display device 10.

First-party contextual data source 50: A first-party service 54 specific to display device 10 that provides data unrelated to the audio the user is currently consuming.

Third-party contextual data source 52: A third-party service 56 that provides data unrelated to the audio the user is currently consuming, such as the time and date, weather, or local news.

Local network contextual data source 62: A local service 64 source running on a device on the end user network 15 that provides data unrelated to the audio the user is currently consuming, such as the indoor temperature, whether the user is at home or not, or other information not available on the Internet.

On-device contextual data source 66: A source originating from display device 10 and/or sensors 68 provided on display device 10, that provides information and data unrelated to the audio currently being consumed, such as ambient brightness, signal strength of local radio sources, a list of devices accessible on the local network, relative noise level near the device, etc.

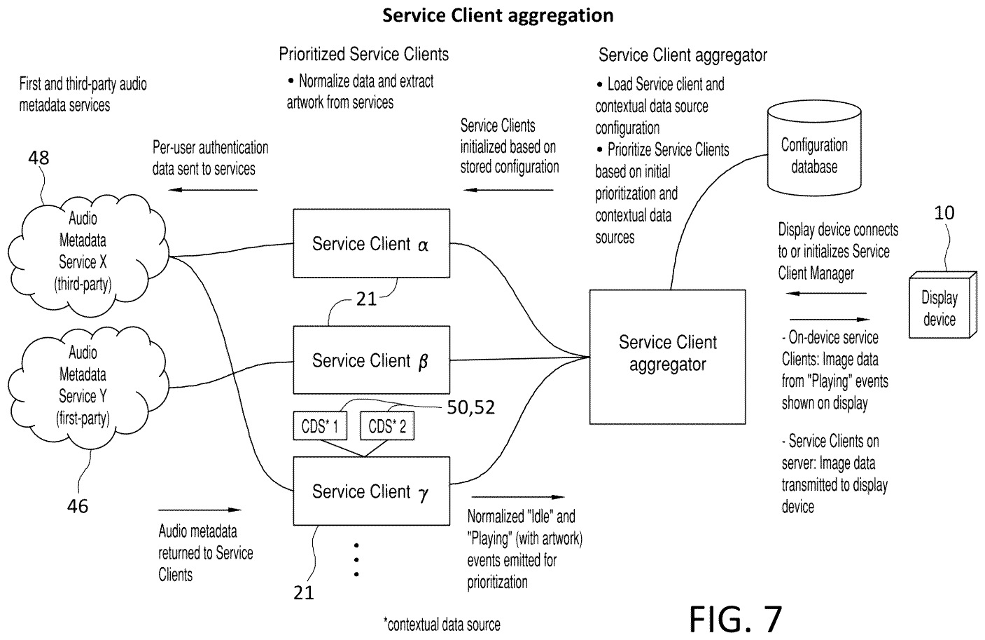

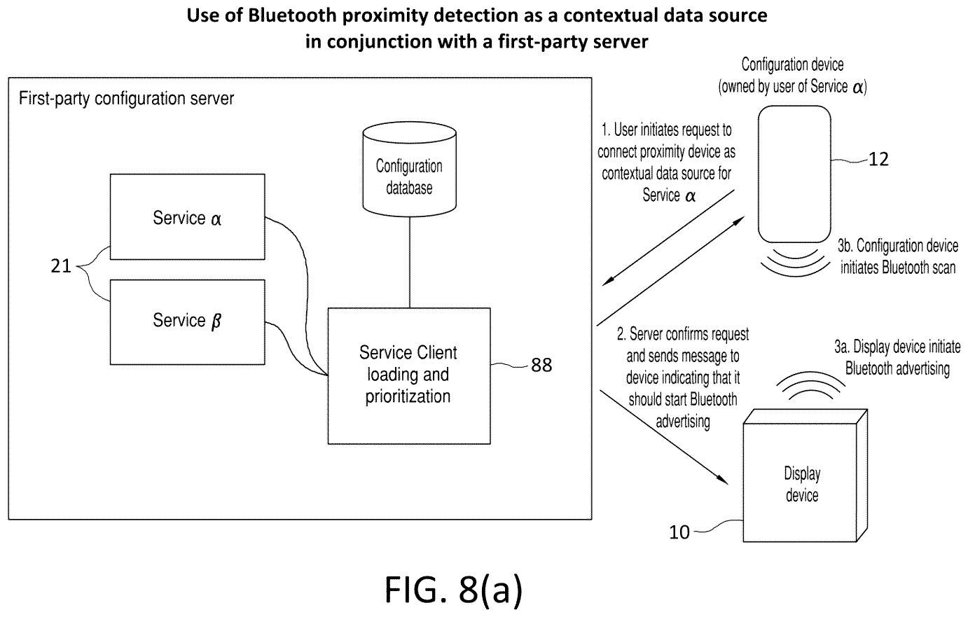

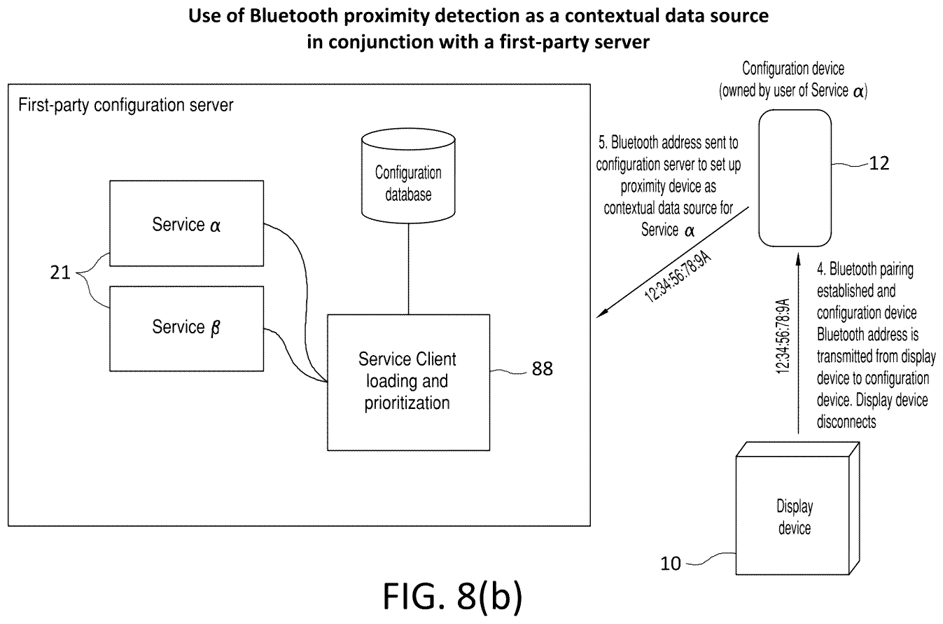

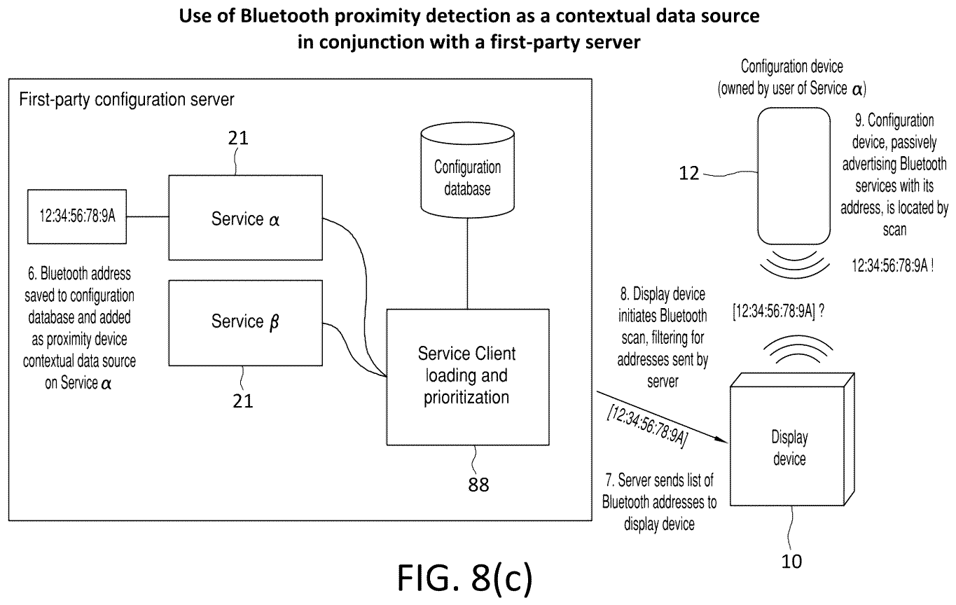

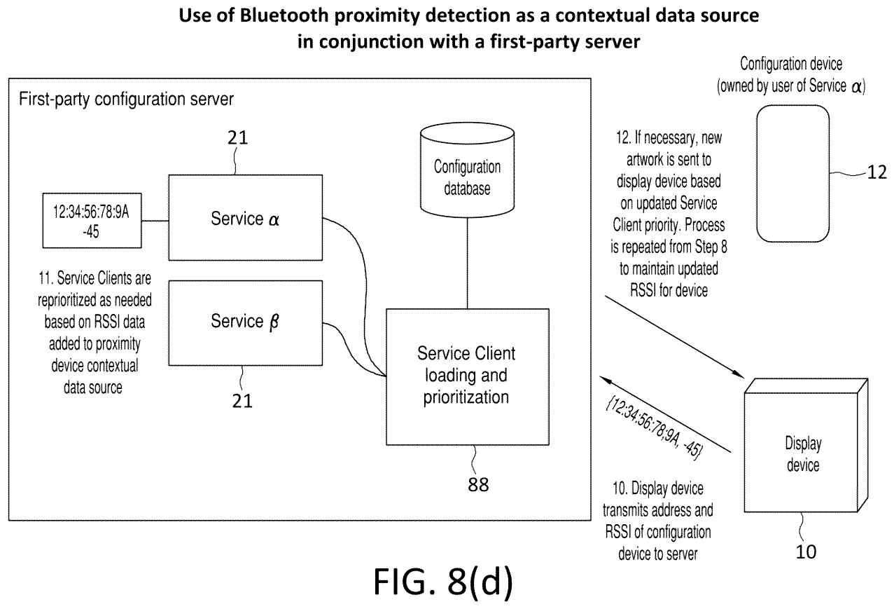

With specific reference now to FIGS. 7 and 8, display device 10 uses a systematized process to normalize (e.g., at step 84 of method 72) sources of audio metadata so that they can be used interchangeably with display device 10.

### Authenticating a Service Client:

Depending on the particularities of the source, a number of methods may be used to authenticate display device 10 with a third-party service. Any resulting authentication data is stored so that it is accessible by an instance of a Service Client 21 corresponding to a particular account or set of accounts from a third-party service. Example authentication processes may include:
Manually entering a username and password for a service to be stored in an encrypted fashion by a Service Client 21.
Using an authentication process such as Oauth on a content player 12) and Configuration Device (e.g., transmitting the resulting tokens to a device or a first-party configuration server so that the tokens can be retrieved by a Service Client 21.
Transmitting after user consent the credentials for a third-party service stored on a Configuration Device owned by the user.

It is possible that an authenticated Service Client 21 can become unauthenticated. If so, the unauthenticated state may be saved on display device 10 or first-party configuration server (e.g, as may be implemented on first-party service 38), and the user may be notified by display device 10 and/or Configuration Device that the user needs to re-authenticate the service.

### Traits of a Service Client:

A Service Client 21 can emit two kinds of events that can be reacted to by other elements of the software system. These events assume that the audio source (e.g., any of audio sources 34, 36, and 58 shown in FIG. 5) or audio metadata source (e.g., any of audio metadata sources 42 and 44) has data that correspond to audio content being reproduced in some fashion such that the user of display device 10 can hear it.

### “Playing” Event:

A Playing event represents a change from an idle state to a state in which audio is playing, or a change from playing one type and/or item of audio content to playing a different type and/or item, and includes metadata including but not limited to, artwork corresponding to the audio content (either as a URL at which the artwork can be accessed in image format, or a static or dynamic image as binary data directly within the Playing event), and additional metadata to be displayed in other contexts (such as on a Configuration Device) where metadata are desired. For a work of music, this might include the track title, artist, album name, composer, record label, etc. For a podcast, it might be the name of the podcast, name of episode, podcast host, episode number, etc. For an audiobook, it might be the name of the book, the name of the author, the chapter title, etc.

If a Service Client 21 is running on a first-party server, the result of the Playing event could be the emission of artwork data in binary format directly to display device 10. If a Service Client 21 is running on display device 10 itself, it would result in the emission of artwork directly to display screen 16.

### “Idle” Event:

This event occurs when changing from a state where content is playing on content player 12 to a state where content is not playing on content player 12.

If a Service Client 21 is running on a first-party server, the result of the “Playing” event could be that of a corresponding “Idle” event sent to display device 10, indicating that the currently displayed artwork should be hidden (i.e., caused not to be displayed on display screen 16). If a Service Client 21 is running on display device 10 itself, it would result in the artwork being hidden directly from display device 10.

### Service Client State:

A Service Client 21 stores the properties of the most recent event or events in volatile or non-volatile memory (depending on the needs of the system).

Normalizing Audio Metadata Sources for Use with a Service Client:

Third-party services may present metadata about audio content and the state of an audio player in any number of formats which must be processed and normalized, i.e., in step 84 of method 72 (FIG. 6) by a corresponding instance of a Service Client 21. Metadata formats include, but are not limited to, structured JSON data, structured XML data, binary data structures, known sets of Bluetooth services and characteristics containing structured or unstructured data, and audio “fingerprinting” that may or may not be detectable by humans.

A Service Client 21 is aware of the expected format of the data from a third-party service and makes use of the appropriate parsers or API clients to process these data. For example, a JSON parser can be implemented to extract metadata from specified paths nested in JSON data, a Bluetooth client can be designed to extract metadata from the expected Bluetooth service characteristics, or a real time audio processor can be used to detect and interpret audio fingerprint data from a microphone and analog-to-digital converter.

Additionally, a Service Client 21 must use this parser or client to determine whether the state is relevant to any corresponding device, possibly in conjunction with prior configuration data or real-time contextual data. For example, the audio metadata may include information about the physical location where audio is being reproduced, and contextual data about where a user is physically located might be used to determine that the user would not be able to see any artwork displayed on display device 10 and therefore an update might be skipped due to irrelevance. Alternatively, the user might make rules about certain types or items of audio content that should not have artwork displayed.

### Metadata Protocols and API Design:

A Service Client 21 normalizes data from a variety of protocols that might be designed in disparate ways. API designs from third-party audio metadata sources may be designed in a multitude of ways, including but not limited to the following examples.

### A Request/Response Cycle for the Current State of an Audio Player:

A third-party service (e.g., third party service 48) might make the current state of an audio player available as the result of a request/response cycle. Service Client 21 stores the credentials necessary to authenticate a request with a third-party server and makes recurring requests to the service to get the current state. Based on the state of the most recent two requests, Service Client 21 can determine when to emit “Playing” and “Idle” events.

Service Client 21 adjusts the frequency of requests based contextual data from the Service Client's audio metadata source as well as other sources of audio metadata or contextual data, such as: Whether or not audio from this source is playing; whether or not audio from a different source is playing; whether the user is nearby a device corresponding to this Service Client 21; whether a device corresponding to this Service Client 21 is powered on; the frequency with which the user manually alters the playback state of this Service Client 21; the amount of time remaining in the currently playing piece of audio content; the time of day or ambient brightness; or any other desired metadata.

Additionally, it is possible that the requests will in fact originate from the third-party service. In this case, the service should be configured so that requests from the third-party service can be routed to a first-party configuration server or to the device itself. If it is routed to a configuration server, the request must contain information that can be used to associate it with a particular Service Client 21, such as a user ID for the third-party service that can be stored in the Service Client's metadata.

### A Request/Response Cycle for a List of Recently Played Items:

While a service might not make available the currently playing item, it might provide a list of recently played items that may or may not contain additional metadata such as the time at which the item was played. A Service Client 21 can use this information to make an educated guess about the current state of an audio or content player.

For example, by recording the most recently played item at any given time, the Service Client 21 can make repeated requests to the third-party service and react when the most recently played item returned by the service changed. The Service Client 21 can use additional metadata, such as the time the item was reproduced, to determine if it is likely that the item is still playing. The Service Client 21 can also track internally when the item first appeared on the list and use this information in conjunction with the duration of the item to determine if the item might still be playing.

A Long-Lived Connection Through which Multiple State Changes are Transmitted:

A service might take advantage of long-lived connections, such as UDP connections, WebSockets or other TCP protocols, or a Bluetooth connection using a protocol such as AVRCP to provide updates about playback state in real time. A Service Client 21 stores the credentials necessary to open a connection and should keep this connection open as long as new artwork can be displayed on a corresponding display device 10, and emit “Playing” and “Idle” events in real time when new data is transmitted over the connection. The Service Client 21 should also implement a process by which the connection can be reestablished if it is lost.

Additionally, it is possible that the connection will in fact originate from the third-party service. If so, the service may be configured so that connections from the third-party service may be routed to a first-party configuration server or to the device itself. If it is routed to a configuration server, the connection must contain information that can be used to associate it with a particular Service Client 21, such as a user ID for the third-party service, that can be stored in the Service Client's metadata. This information can be transmitted when opening the connection or can be included in individual state change messages if multiple accounts share a connection.

### Using an Auxiliary Audio Metadata Source:

It is possible that a source of third-party audio content might either lack audio metadata which may be available with the use of other sources of audio metadata, or provide metadata that is ignored based on the configuration of a Service Client 21 either by the producer of the device or by the user of display device 10.

For example, a particular musical artist might partner with the manufacturer of display device 10 to provide custom artwork available only for owners of a special edition of display device 10. For these devices, a custom metadata rule would be implemented, indicating that for particular combinations of metadata from audio sources (for example, a match on both the artist and song name fields), an alternate source of metadata should be used in order to display the artwork corresponding to the special edition of display device 10.

Another example is an audio source where the presence or lack of metadata is dependent on the user, such as music stored on a user's device that has an artist and album name saved but not artwork. In this case, the Service Client 21 may use an alternative source of metadata either configured by the user or the manufacturer to provide the missing artwork.

Referring now to FIGS. 6 and 7, optional step 82 of method 72 associates contextual data with audio metadata. As mentioned earlier, contextual data are data that are unrelated to the audio the user is consuming. A Service Client 21 might be configured to use contextual data sources (e.g., contextual data sources 50 and 52) in addition to audio metadata sources to provide alternate artwork or behavior.

Consider, for example, a scenario wherein a user wants third-party service “A” to only show artwork if audio content from that service is playing from 8 AM to 10 PM. Either on display device 10 or Configuration Device (e.g., content player 12), the appropriate Service Client 21 for service “A” would be connected with a clock, which would serve as a contextual data source, with data provided by a first-party server, a third-party server, or a device owned by the user.

If desired, this contextual data source could be connected to all Service Clients 21 on a device with shared configuration.

### Bluetooth Proximity Detection for Data Source Selection:

Referring now to FIGS. 8(a-d), it may be desirable for display device 10 or Service Client 21 to behave differently depending on whether another Bluetooth-capable device, such as a user's smartphone, is detected nearby. User's smartphone may comprise content player 12. In this context, the user's smartphone would be considered a Proximity Device by display device 10 and Service Client 21.

To implement this feature, the user should be presented with an option on the user's Configuration Device (e.g., content player 12) to add the Configuration Device as a Proximity Device.

When activating this option, data must be transmitted to display device 10 to indicate that a Bluetooth pairing process should be initiated. If Configuration Device uses a first-party configuration service, this can be accomplished by transmitting data to the configuration service from the Configuration Device, which then notifies the connected display device 10 to begin a pairing process. If the Configuration Device is operating without a first-party configuration service, this data could be transmitted over Bluetooth, over a local network, or using another short-range communication technology such as near field communication (NFC).

Once these data are transmitted, the Configuration Device performs a Bluetooth scan to see if the relevant display device 10 is advertising its Bluetooth services. The Configuration Device then initiates a connection when display device 10 is found.

If display device 10 uses on-device Service Clients 21 to receive artwork, it can now store the Bluetooth MAC address of the Configuration Device in non-volatile memory so that it can be retrieved for future use and associated as a Proximity Device with one or more Service Clients 21. See FIG. 8(c).

If display device 10 uses Service Clients 21 running on a first-party configuration server, display device 10 must then make the Bluetooth MAC address of the Configuration Device as resolved by the display device available as a Bluetooth service characteristic. The Configuration Device can read this characteristic so that it knows its own MAC address as seen by display device 10. This step is necessary because the manufacturers of the Configuration Device may make the Bluetooth MAC address unavailable directly in software for privacy reasons and may use a resolvable private address that can only be used by display device 10 once pairing has completed. Reading the MAC address of the Configuration Device directly from display device 10 ensures that the MAC address remains consistent. This MAC address is then transmitted by the Configuration Device to the first-party configuration server and stored in conjunction with display device 10 so that it can be associated as a Proximity Device with Service Clients 21 running on the configuration server.

While operating, display device 10 either uses internally stored Proximity Device MAC addresses or retrieves them from the configuration server and continuously performs a scan for Bluetooth devices. If any devices in the scan match a MAC address of a Proximity Device, the signal strength of the Bluetooth signal from the Proximity Device is either stored on display device 10 or transmitted to the first-party configuration server. For Proximity Devices with resolvable private addresses, display device 10 must also store the identity resolving key for the private address so it can be resolved during scanning.

The user may then use the signal strength of the Proximity Device as a contextual data source for one or more Service Clients 21. For example, a third-party audio service might record a user as playing audio whether they are near or far from display device 10, and the user might want to only show artwork on display device 10 if the user is near enough to see the display. In this case, the user can specify a minimum Proximity Device signal strength for a particular Proximity Device and associate that configuration with one or more Service Clients 21 to achieve this function.

Once a user has connected a Proximity Device, the user can add it to multiple Service Clients 21 without initiating the pairing process again by loading the list of Proximity Devices currently associated with that display device 10.

### Prioritization of Data Sources:

In order to effectively use multiple Service Clients 21 with one device, the user may prioritize the Service Clients 21 so that appropriate artwork can be shown. This can be achieved in accordance with method 88 illustrated in FIG. 9. Method 88 involves a combination of factors related to audio metadata sources and contextual data sources. Briefly, method 88 may involve the following aspects: A base prioritization of Service Clients 21 from highest priority to lowest priority; the state of a Service Client 21 (e.g., “Playing” or “Idle”); and the Association of Service Clients 21 with contextual data sources and assignment of a metaprioritization value for a particular contextual data source/Service Client 21 combination.

In a first step 27 of method 88, the user identifies the particular Service Clients 21 desired to be prioritized. In the example illustrated in FIG. 10, the list of identified Service Clients 21 includes Service Client α, Service Client β, and Service Client γ. Then, in step 29, the user assigns a prioritization value to each identified Service Client 21 by assigning them prioritization values. In the particular example illustrated in FIG. 10, those prioritization values are represented by the letters “A,” “B,” and “C,” with A being highest priority, B next highest, and so on. In step 31, the user associates contextual data sources, e.g., contextual data sources 50 and 52 with their corresponding Service Clients 21. In this regard it should be noted that not all Service Clients 21 will have an associated contextual data source, while other Service Clients 21 may have more than one associated contextual data source. This is illustrated in FIG. 10, wherein Service Client β does not have an associated contextual data source, but where Service Client γ has two (2) associated contextual data sources.

In step 33, the contextual data source(s) (if any) associated with each Service Client 21 are assigned a metaprioritization value (MPV). The MPV may be assigned based on contextual data produced or sensed by the contextual data source(s). In the particular embodiments shown and described herein, the metaprioritization value (MPV) may be assigned an integer value from zero up to some defined maximum value. An MPV of zero indicates a deprioritized service account, 1 indicates default priority, and numbers greater than 1 indicate increasingly higher priorities.

After an MPV has been assigned to each contextual data source, method 88 proceeds to step 35 to detect the state (e.g., Playing or Idle) of each Service Client 21 or contextual data source. If a state change is detected, then method 88 creates a list of Service Clients 21 that are in a Playing state. Service Clients 21 in the Idle state are omitted from the list and not considered further unless and until their state changes from Idle to Playing, for example. If no Service Clients 21 are playing, then the process is complete and no artwork is shown. In the example illustration in FIG. 10, only Service Clients β and γ are placed in the list, as Service Client α is in the Idle state.

Step 39 determines the MPVs for the highest priority Service Client 21. Then, in step 41, the highest priority MPV (i.e., the MPV with the highest integer value for Service Clients 21 with multiple MPVs) is assigned to that corresponding or associated Service Client 21. If the state of any of the contextual data sources corresponds to a metaprioritization value (MPV) that is other than 1, then that value is stored as that Service Client's MPV. The final MPV for each Service Client 21 is the MPV for the highest priority contextual data source for which the metaprioritization value is not 1. If no contextual data sources have MPVs other than 1, the MPV of the Service Client is 1. Note that in some embodiments, the MPVs might be assigned by the end user or hard-coded by the designer of the device and it may not be necessary to reveal the MPVs values to the user. Steps 39 and 41 are then repeated (e.g., at step 43) for the Service Client 21 having the next lower user-assigned priority (e.g., A, B, C, etc.), until the highest MPV value for each Service Client 21 has been assigned. Thereafter, step 45 groups the Service Clients 21 by the highest assigned MPV value. That is, step 45 effectively creates a priority list for the Service Clients 21 based on their state (e.g., Playing), the user-assigned priority, and the MPV for each Service Client 21. Then, at step 47, the system displays the artwork on display device 10 for the Service Client 21 having the highest assigned MPV for its corresponding audio content. In the example illustrated in FIG. 10, that would be Service Client γ.

### EXAMPLE

The prioritization process 88 of FIG. 9 may be better understood by considering an example, schematically illustrated in FIG. 10, that involves the prioritization of a plurality of Service Clients 21 and associated contextual data sources.

In the example illustrated in FIG. 10, three Service Clients 21, identified as Service Clients α, β, and γ, are assigned respective priorities “A,” “B,” and “C” by the user. Service Client α is currently in the Idle state and has associated with it a clock as a contextual data source (the contextual data source for Service Client α is not specifically shown in FIG. 10). Service Client β is currently in the Playing state, but has no associated contextual data source. Service Client γ is also in the Playing state, and has two associated contextual data sources: A clock and a proximity device.

An MPV value may be assigned to each contextual data source and may vary depending on the particular data produced by the contextual data source. For example, if the contextual data source comprises a clock, the MPV may be set equal to 1 (i.e., MPV=1) if the time is between certain defined hours, say between 9 AM and 5 PM. For other times, the MPV may be set equal to zero (i.e., MPV=0). If the associated contextual data source is a proximity device, the MPV may be set equal to zero (i.e., MPV=0) if the signal strength of the proximity device below some defined signal strength, say less than or equal to −100. Otherwise, e.g., for stronger signals, the MPV may be set equal to two (i.e., MPV=2). Alternatively, of course, other MPV values could be used. Note that if no contextual data source is associated with a Service Client 21 (e.g., such as Service Client β), then the MPV may be set equal to zero (i.e., MPV=0) by default. In the description provided below, the assigned MPVs for the corresponding contextual data sources are rendered in underlined text.

After the Service Clients 21 (e.g., Service Clients α, β, and γ) have been prioritized by the user (and associated with contextual data sources, if any), the status of each Service Client 21 and associated contextual data source(s) (if any) is as follows:

### User Assigned Priority A:

Service Client α
State: Idle
Contextual data source (a clock between 9 AM and 5 PM): MPV=1

### User Assigned Priority B:

Service Client β
State: Playing
Contextual data source: None. MPV=0 (default)

### User Assigned Priority C:

Service Client γ
State: Playing
Contextual data source #1 (a proximity device): MPV=2
Contextual data source #2 (a clock): MPV=0

After the Service Clients 21 that are in the Idle state (e.g., Service Client α in this example) are omitted or withdrawn from consideration, the status of each remaining Service Client 21 (e.g., Service Clients β and γ) is as follows:

### User Assigned Priority B:

Service Client β
State: Playing
Contextual Data Source: None. MPV=0 (default)

### User Assigned Priority C:

Service Client γ
State: Playing
Contextual data source #1 (proximity device): MPV=2
Contextual data source #2 (clock): MPV=0

The remaining Service Clients 21 (e.g., Service Clients β and γ) are then grouped based on the MPVs of the contextual data sources. Note that for Service Clients 21 having multiple contextual data sources (such as Service Client γ in this example) only the highest MPV is used in the grouping process. The lower MPV(s) are discarded or ignored. The status of each grouped Service Client 21 (e.g., Service Clients β and γ) is as follows:

Service Clients with MPV=2:
Service Client γ (i.e., User Assigned Priority C)
State: Playing
Contextual data source #1 (proximity device): MPV=2
Contextual data source #2 (clock): MPV=0 (the MPV of contextual data source #2 is discarded or ignored because it is lower than the MPV of contextual data source #1)
   Service Clients with MPV=1:
None (Service Client α is Idle, thus not considered)
   Service Clients with MPV=0:
Service Client β (i.e., User Assigned Priority B)
State: Playing
Contextual data source: None. MPV=0 (default)

The result of process 88 of FIG. 9 and illustrated schematically in FIG. 10 is that the artwork from Service Client γ is displayed on display device 10, even though Service Client γ started with the lowest user-assigned priority (i.e., priority C) initially. This is due to the fact that process 88 also considers the MPV(s) of the contextual data source(s).

Managing Data Sources from Multiple Users:

After configuring a display device 10, a user might choose to permit other users to add Service Clients 21 and change other settings related to display device 10, for example if display device 10 is used in a shared space in a household with multiple residents.

In this case, user A can use his/her Configuration Device to create an invitation token for user B, which is sent to user B as a part of a URL. User B opens this URL, which allows one-time use of the invitation token to attach an additional Service Client 21 connected to an account owned by user B to display device 10 via a user interface which may be displayed via a web browser or a mobile app.

Depending on user A's wishes, user B may be permitted full access to all settings of display device 10 (e.g., all Service Clients 21, contextual data sources, prioritizations, etc.) or may have his/her access limited to some or all of this scope.

An invitation token may have an expiry date after which any Service Client 21 added by the user is removed from display device 10. This allows guest access to display device 10.

### Additional Features

Controlling First and Third-Party Audio Services Directly with Display Device 10:

An audio service that allows the playback state to be changed via its API can be controlled with optional user input devices 92 (FIG. 2) provided on display device 10. As mentioned earlier, user input devices 92 allow the user to physically interact with his or her audio content without needing to use a separate smartphone or computer. User input device 92 may also include additional interactive elements, such as directional controls, a touch sensitive display, or a control knob in order to browse recently played items. These controls can allow selecting different Service Clients 21 as audio sources and browsing audio content on those sources. The ability to use user input devices 92 provided on display device 10 replicates the physical experience of browsing audio content and reduces the need for a computer or smartphone to choose audio content.

### Suggesting Exclusive or Alternate Audio Content:

A creator or publisher of audio content could offer exclusive access to alternate or special versions of their content in conjunction with use of display device 10. Because users will connect display device 10 to multiple sources of audio content, a Service Client 21 connected to any number of data sources can detect when content from such a creator or publisher is playing and notify the user of display device 10 that the alternate version is available. This notification may be provided by means of a visual or aural indicator (e.g., if display device 10 is provided with an optional speaker(s) 94) on display device 10 itself or in the form of a notification powered by the operating system of a smartphone or computer (e.g., content player 12). The audio content can be stored on the device or on the first-party configuration server, and can be controlled by display device 10 or by a Configuration Device. Additionally the exclusive audio content could augment instead of replacing the relevant audio content. If provided, speaker(s) 94 (FIG. 2) provided on display device 10 or associated with content player 12 could provide commentary or other additional content to create an exclusive experience.

Unless defined otherwise, all technical and scientific terms used herein have the same meaning as commonly understood by persons having ordinary skill in the art to which the invention pertains. Although any methods and materials similar or equivalent to those described herein can be used in practice for testing of the present invention, the preferred materials and methods are described herein.

In understanding the scope of the present invention, the articles “a” and “an” are used herein to refer to one or to more than one (i.e., to at least one) of the grammatical object of the article. By way of example, “an element” means one element or more than one element. The term “comprising” and its derivatives, as used herein, are intended to be open ended terms that specify the presence of the stated features, elements, components, groups, and/or steps, but do not exclude the presence of other unstated features, elements, components, groups, and/or steps. The foregoing also applies to words having similar meanings such as the terms, “including,” “having” and their derivatives. Any terms of degree such as “substantially,” “about” and “approximate” as used herein mean a reasonable amount of deviation of the modified term such that the end result is not significantly changed. When referring to a measurable value, such as an amount, a temporal duration, and the like, these terms are meant to encompass variations of at least ±20% or ±10%, more preferably ±5%, even more preferably ±1%, and still more preferably ±0.1% from the specified value, as such variations are appropriate and as would be understood by persons having ordinary skill in the art to which the invention pertains.

Throughout this disclosure, various aspects of the invention may be presented in a range format. It should be understood that the description in a range format is merely for convenience and brevity and should not be construed as an inflexible limitation on the scope of the invention. Accordingly, the description e should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.6, 3, 4, 5, 5.7, and 6. This applies regardless of the breadth of the range.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adapted to another embodiment. It should be noted that while the present invention is shown and described herein as it could be used in conjunction with a configuration of various components, it could be utilized with other configurations, either now known in the art or that may be developed in the future, so long as the objects and features of the invention are achieved, as would become apparent to persons having ordinary skill in the art after having become familiar with the teachings provided herein. Consequently, the present invention should not be regarded as limited to that shown and described herein. It is not necessary for all advantages to be present in a particular embodiment at the same time. Thus, the foregoing descriptions of the embodiments according to the present invention are provided for illustration only, and not for the purpose of limiting the invention as defined by the appended claims and their equivalents.

Having herein set forth preferred embodiments of the present invention, it is anticipated that suitable modifications can be made thereto which will nonetheless remain within the scope of the invention. The invention shall therefore only be construed in accordance with the following claims:

1. A display device, comprising:
a housing;
a display screen mounted to said housing;
a processor disposed within said housing and operatively connected to said display screen;
a memory system disposed within said housing and operatively associated with said processor;
a communications interface system disposed within said housing and operatively associated with said processor, said communications interface system receiving artwork data relating to audio source material, said processor operating said display screen to display the artwork data when the audio source material is being played by a content player separate from said display device.

2. The display device of claim 1, wherein said housing is configured to receive said display screen so that the combination of said housing and said display screen appears to be bezel-less.

3. The display device of claim 1, wherein said housing is configured to receive said display screen so that the combination of said housing and said display screen lacks a bezel.

4. The display device of claim 1, wherein said housing is configured to receive said display screen so that the combination of said housing and said display screen defines a bezel along a bottom portion of said display screen.

5. The display device of claim 1, wherein said housing defines a base of said display device and wherein said display screen defines a face portion of said display device, the face portion being substantially perpendicular to the base so that when the base of said display device is placed on a surface, the face portion is substantially perpendicular to the surface.

6. The display device of claim 1, wherein said housing defines a base of said display device and wherein said display screen defines a face portion of said display device, the face portion not being substantially perpendicular to the base so that when the base of said display device is placed on a surface, the face portion is angled upwardly with respect to the surface.

7. The display device of claim 1, further comprising at least one user input device mounted to said housing, said at least one user input device being operatively associated with said processor to control one or more functions of said display device.

8. The display device of claim 7, wherein said at least one user input device comprises one or more selected from the group consisting of buttons, knobs, and switches.

9. The display device of claim 1, wherein said communications interface system comprises a wireless communications interface system.

10. The display device of claim 1, wherein said communications interface system comprises a wired communications interface system.

11. The display device of claim 1, wherein said display screen has a width-to-height aspect ratio of about 1:1.

12. The display device of claim 1, wherein said display screen has a resolution of less than about 49 pixels/cm².

13. The display device of claim 12, wherein said display screen has a resolution of 16 pixels/cm².

14. The display device of claim 1, wherein said display screen comprises a plurality of light emitting diodes.

15. The display device of claim 1, wherein said display has a maximum luminance greater than about 1500 candelas per square meter (cd/m²).

16. The display device of claim 1, further comprising an audio transducer operatively associated with said processor.

17. A display device, comprising:
a housing, said housing defining a base, a top side, a left side, a right side, and a back side, the base, top, left, right, and back sides defining an open front of said housing;
a display screen mounted to the open front of said housing so that said display screen defines a generally square face portion of said display device and so that said display screen and said housing define an interior cavity therein;
a processor disposed within the interior cavity and operatively associated with said display screen;
a memory system disposed within the interior cavity and operatively associated with said processor;
a communications interface system disposed within the interior cavity and operatively associated with said processor, said communications interface system receiving artwork data relating to audio source material, said processor operating said display screen to display the artwork data when the audio source material is being played by a content player separate from said display device.

18. The display device of claim 17 further comprising a power source operatively connected to said display screen, said processor, said memory system, and said communications interface system.

19. The display device of claim 18, wherein said housing comprises wood.

20. The display device of claim 19, wherein the open front of said housing is substantially square and wherein the display screen is substantially square and has about the same dimensional extent as the open front of said housing so that the combination of said housing and said display screen appears to be bezel-less.

21. The display device of claim 17, wherein said housing defines a base of said display device and wherein said display screen defines a face portion of said display device, the face portion not being substantially perpendicular to the base so that when the base of said display device is placed on a surface, the face portion is angled upwardly with respect to the surface.

22. The display device of claim 17, further comprising at least one user input device mounted to said housing, said at least one user input device being operatively associated with said processor to control one or more functions of said display device.

23. The display device of claim 17, wherein said display screen comprises a plurality of light emitting diodes.

24. The display device of claim 23, wherein said display screen has a maximum luminance greater than about 1500 cd/m².

25. A method of displaying artwork data associated with audio source material, comprising:
providing a display device comprising:
a housing;
a display screen mounted to said housing;
a processor disposed within said housing and operatively connected to said display screen;
a memory system disposed within said housing and operatively associated with said processor;
a communications interface system disposed within said housing and operatively associated with said processor;
operating the display device to receive at the display device, via said communications interface system, artwork data relating to audio source material, the processor of the display device operating the display screen to display the artwork data when the audio source material is being played by a content player separate from the display device.

26. The method of claim 25, further comprising normalizing the artwork data before the artwork data are displayed on the display screen.

27. The method of claim 25, wherein the artwork data comprise a portion of audio metadata associated with the audio source material, and wherein said method further comprises removing from the audio metadata data unrelated to the artwork data.

28. The method of claim 25, wherein the audio source material is provided by a plurality of Service Clients and wherein said method further comprises assigning a user priority to each of the plurality of Service Clients.

29. The method of claim 28, further comprising:
associating contextual data sources with at least some of the plurality of Service Clients; and
assigning a metaprioritization value (MPV) to each contextual data source.

30. The method of claim 29, wherein assigning a MPV to each contextual data source comprises assigning an MPV to each contextual data source based on data from each corresponding contextual data source.

31. The method of claim 29, further comprising:
determining a state for each of the plurality of Service Clients;
determining the MPV of corresponding contextual data sources of the Service Clients in a Playing State; and
selecting as a chosen Service Client that Service Client with the highest MPV.

32. The method of claim 31, wherein at least some of the Service Clients have associated with them a plurality of contextual data sources, said method further comprising: For each Service Client that comprises a plurality of contextual data sources, assigning an MPV for the Service Client the highest MPV of the MPVs of each of the plurality of contextual data sources.

33. A non-transitory computer-readable storage medium having computer-executable instructions embodied thereon that, when executed by at least one computer processor, cause the processor to operate a display device operatively associated with a content player separate from the display device to receive at the display device, via a communications interface system of the display device, artwork data relating to audio source material, a processor of the display device operating a display screen of the display device to display the artwork data when audio source material is being played by the content player.

34. The storage medium of claim 33, further comprising instructions to normalize the artwork data before the artwork data are displayed on the display screen.

35. The storage medium of claim 33, wherein the artwork data comprise a portion of audio metadata associated with the audio source material, wherein said instructions further comprise instructions to remove from the audio metadata data unrelated to the artwork data before the artwork data are displayed on the display screen.

36. The storage medium of claim 33, wherein the audio source material is provided by a plurality of Service Clients and wherein said instructions further comprise instructions to assign a user priority to each of the plurality of Service Clients.

37. The storage medium of claim 36, wherein said instructions further comprise instructions to:
associate contextual data sources with at least some of the plurality of Service Clients; and
assign a metaprioritization value (MPV) to each contextual data source based on contextual data.

38. The storage medium of claim 37, wherein said instructions further comprise instructions to:
determine a state for each of the plurality of Service Clients;
determine the MPV of corresponding contextual data sources of the Service Clients in a Playing State; and
select as a chosen Service Client that Service Client with the highest MPV.

39. The storage medium of claim 38, wherein at least some of the Service Clients have associated with them a plurality of contextual data sources, and wherein said instructions further comprise instructions that, for each Service Client that comprises a plurality of contextual data sources, assign an MPV for the Service Client the highest MPV of the MPVs of each of the plurality of contextual data sources.
